(19) United States
(12) Patent Application Publication
(10) Pub. No.: US 2025/0386027 A1
(43) Pub. Date: Dec. 18, 2025

(54) DEEP VIDEO CODING WITH BLOCK-BASED MOTION ESTIMATION

(71) Applicant: Fraunhofer-Gesellschaft zur Förderung der angewandten Forschung e.V., München (DE)

(72) Inventors: Sophie PIENTKA, Berlin (DE); Michael SCHÄFER, Berlin (DE); Jonathan PFAFF, Berlin (DE); Heiko SCHWARZ, Berlin (DE); Detlev MARPE, Berlin (DE); Thomas WIEGAND, Berlin (DE)

(21) Appl. No.: 19/302,635

(22) Filed: Aug. 18, 2025

Related U.S. Application Data
(63) Continuation of application No. PCT/EP2024/054548, filed on Feb. 22, 2024.

(30) Foreign Application Priority Data
Feb. 22, 2023 (EP) 23158083.8

(51) Int. Cl. H04N 19/137; H04N 19/172; H04N 19/176; H04N 19/42

(52) U.S. Cl. CPC H04N 19/137; H04N 19/172; H04N 19/176; H04N 19/42

(57) ABSTRACT

An apparatus for determining an encoding of a motion field for a picture of a video sequence comprising a sequence of pictures, such that said picture is decodable using a reference picture, the motion field and the residual, according to an embodiment is provided. The apparatus comprises a trained neural network configured to determine the encoding of the motion field, being associated with said picture, depending on said picture and depending on the reference picture.

### CROSS-REFERENCES TO RELATED APPLICATIONS

This application is a continuation of copending International Application No. PCT/EP2024/054548, filed Feb. 22, 2024, which is incorporated herein by reference in its entirety, and additionally claims priority from European Application No. 23 158 083.8, filed Feb. 22, 2023, which is incorporated herein by reference in its entirety.

The present invention relates to video coding, in particular, to deep video coding, and, more particularly, to deep video coding with block-based motion estimation.

### BACKGROUND OF THE INVENTION

The research on deep-learned end-to-end video compression has impressively advanced over the course of recent years. These methods typically perform motion-compensated prediction by using convolutional neural networks which determine a compressed representation of the motion field as features. A common approach is to divide this task into searching suitable motion vector by one network and efficiently storing them by another one. However, these networks may find motion fields far from optimal because they are often treated as a black box without regard to which similarities between original and reference frame can be exploited.

Inter-prediction is a cornerstone of all block-based, hybrid video codecs such as H.264/AVC (see [1]), H.265/HEVC (see [2]), H.266/VVC (see [3], [4]) by exploiting temporal redundancies between frames. Here, to generate the prediction, a motion vector field is determined by the encoder. Then, both the motion field and the prediction residual are coded in the bitstream. For typical video sequences, the rate to transmit the motion information contributes a significant part of the overall bitrate.

Following the end-to-end approach from still image compression (see [5]), methods to efficiently represent and transmit motion by features in a latent space have been developed recently. The first end-to-end deep video compression framework called DVC was proposed by Lu et al (see [6]). In this approach, a pre-trained network to estimate the optical flow and jointly trained autoencoders for motion compensation and residual coding are used. In [7],Lu et al. improved the DVC framework by updating the encoder for each frame.

Agustsson et al. (see [8]) introduced an end-to-end deep video compression framework in which the first frame, the motion information and the residual are transmitted using three jointly trained but seperately applied autoencoders. They also introduced the scale-space flow which appends a third component for the motion field which assigns an uncertainty parameter to each motion vector.

In the context of hybrid block-based video coding, different search strategies to efficiently determine suitable motion vectors at the encoder have been developed (see [9], [10]). As a full search testing all possible candidates is computationally too expensive, diamond or logarithmic search (see [11], [12]) has become a well-established method to reduce the number of comparisons.

It should be noted that the search is typically designed to minimize a cost criterion that takes into account both the prediction accuracy and the rate to transmit the motion information. Since motion vectors are often coded predictively, the minimal sum of absolute differences between a motion vector candidate and the motion vectors of neighboring blocks is suitable as an approximation of the rate. Such a comparison between neighboring motion vectors is also related to the smoothness constraint for the optical flow which was introduced by Horn et al. (see [13], see also [14], [15]).

### SUMMARY

An embodiment may have an apparatus for determining an encoding of a motion field for a picture of a video sequence comprising a sequence of pictures, such that said picture is decodable using a reference picture, the motion field and the residual, wherein the apparatus comprises a trained neural network configured to determine the encoding of the motion field, being associated with said picture, depending on said picture and depending on the reference picture.

Another embodiment may have an apparatus for encoding, wherein the apparatus is configured to encode a video sequence comprising a sequence of pictures to acquire encoded video data, wherein the apparatus is configured to generate the encoded video data such that each picture of one or more pictures of the video sequence is encoded by an encoding of a motion field and a residual, such that said picture is decodable using a reference picture, the motion field and the residual; wherein the apparatus comprises a trained neural network configured to determine the encoding of the motion field, being associated with said picture, depending on said picture and depending on the reference picture.

Another embodiment may have an apparatus for decoding, wherein the apparatus for decoding is configured to receive encoded video data encoding a video sequence comprising a sequence of pictures, wherein the apparatus for decoding is configured to decode the video from the encoded video data, wherein the apparatus for decoding is suitable to decode the video sequence from encoded video data being generated by an apparatus for encoding according to the invention.

Another embodiment may have a system, comprising: an apparatus for encoding according to the invention, and an apparatus for decoding according to the invention, wherein the apparatus for encoding is configured to encode a video sequence comprising a sequence of pictures to acquire encoded video data, wherein the apparatus for decoding is configured to receive the encoded video data which has been generated by the apparatus for encoding, and wherein the apparatus for decoding is configured to decode the video sequence from the encoded video data that has been generated by the apparatus for encoding.

Another embodiment may have a method for determining an encoding of a motion field for a picture of a video sequence comprising a sequence of pictures, such that said picture is decodable using a reference picture, the motion field and the residual, wherein the method comprises determining the encoding of the motion field, being associated with said picture, depending on said picture and depending on the reference picture using a trained neural network.

Another embodiment may have a method for encoding, wherein the method comprises encoding a video sequence comprising a sequence of pictures to acquire encoded video data, wherein the method comprises generating the encoded video data such that each picture of one or more pictures of the video sequence is encoded by an encoding of a motion field and a residual, such that said picture is decodable using a reference picture, the motion field and the residual; wherein determining the encoding of the motion field, being associated with said picture, is conducted depending on said picture and depending on the reference picture using a trained neural network.

Another embodiment may have a method comprising: receiving encoded video data encoding a video sequence comprising a sequence of pictures, and decoding the video sequence from the encoded video data, wherein the encoded video data has been generated in accordance with the method according to the invention.

Another embodiment may have a method for training a neural network, wherein the neural network is to determine an encoding of a motion field for a picture of a video sequence comprising a sequence of pictures, such that said picture is decodable using a reference picture, the motion field and the residual,
wherein the method comprises training the neural network using a minimization function or optimization function, which depends on a predicted picture and an original picture, wherein the predicted picture is a picture that results from decoding using a reference picture and a motion field which are associated with said predicted picture.

Another embodiment may have a computer program for implementing the methods according to the invention when being executed on a computer or signal processor.

Another embodiment may have encoded video data, wherein the encoded video data encodes a video sequence comprising a sequence of pictures, wherein the encoded video data has been generated by an apparatus for encoding according to the invention, and/or wherein the encoded video data has been generated in accordance with the method according to the invention.

Another embodiment may have video data stream, wherein the video data stream comprises encoded video data encoding a video sequence comprising a sequence of pictures, wherein the video data stream has been generated by an apparatus for encoding according according to the invention, and/or wherein the video data stream has been generated in accordance with the method according to the invention.

An apparatus for determining an encoding of a motion field for a picture of a video sequence comprising a sequence of pictures, such that said picture is decodable using a reference picture, the motion field and the residual, according to an embodiment is provided. The apparatus comprises a trained neural network configured to determine the encoding of the motion field, being associated with said picture, depending on said picture and depending on the reference picture.

Moreover, an apparatus for encoding according to an embodiment is provided. The apparatus is configured to encode a video sequence comprising a sequence of pictures to obtain encoded video data. Furthermore, the apparatus is configured to generate the encoded video data such that each picture of one or more pictures of the video sequence is encoded by an encoding of a motion field and a residual, such that said picture is decodable using a reference picture, the motion field and the residual. Moreover, the apparatus comprises a trained neural network configured to determine the encoding of the motion field, being associated with said picture, depending on said picture and depending on the reference picture.

Furthermore, an apparatus for decoding according to an embodiment is provided. The apparatus for decoding is configured to receive encoded video data encoding a video sequence comprising a sequence of pictures. Moreover, the apparatus for decoding is configured to decode the video from the encoded video data. Furthermore, the apparatus for decoding is suitable to decode the video sequence from encoded video data being generated by an apparatus for encoding according to the above-described embodiment.

Moreover, a system according to an embodiment is provided. The system comprises an apparatus for encoding according to the above-described embodiment and an apparatus for decoding according to the above-described embodiment. The apparatus for encoding is configured to encode a video sequence comprising a sequence of pictures to obtain encoded video data. The apparatus for decoding is configured to receive the encoded video data which has been generated by the apparatus for encoding. Moreover, the apparatus for decoding is configured to decode the video sequence from the encoded video data that has been generated by the apparatus for encoding.

Furthermore, a method for determining an encoding of a motion field for a picture of a video sequence comprising a sequence of pictures, such that said picture is decodable using a reference picture, the motion field and the residual, according to an embodiment is provided. The method comprises determining the encoding of the motion field, being associated with said picture, depending on said picture and depending on the reference picture using a trained neural network.

Moreover, a method for encoding according to an embodiment is provided. The method comprises encoding a video sequence comprising a sequence of pictures to obtain encoded video data. Furthermore, the method comprises generating the encoded video data such that each picture of one or more pictures of the video sequence is encoded by an encoding of a motion field and a residual, such that said picture is decodable using a reference picture, the motion field and the residual. Determining the encoding of the motion field, being associated with said picture, is conducted depending on said picture and depending on the reference picture using a trained neural network.

Furthermore, a method according to another embodiment is provided. The method comprises receiving encoded video data encoding a video sequence comprising a sequence of pictures, and decoding the video sequence from the encoded video data. The encoded video data has been generated in accordance with the method for encoding as described above.

Moreover, a method for training a neural network according to an embodiment is provided. The neural network is to determine an encoding of a motion field for a picture of a video sequence comprising a sequence of pictures, such that said picture is decodable using a reference picture, the motion field and the residual. The method comprises training the neural network using a minimization function or optimization function, which depends on a predicted picture and an original picture, wherein the predicted picture is a picture that results from decoding using a reference picture and a motion field which are associated with said predicted picture.

Furthermore, computer programs are provided, wherein each of the computer programs is configured to implement one of the above-described methods when being executed on a computer or signal processor.

Moreover, encoded video data according to an embodiment is provided. The encoded video data encodes a video sequence comprising a sequence of pictures. Moreover, the encoded video data has been generated by an apparatus for encoding as described above, and/or the encoded video data has been generated in accordance with the method for encoding as described above.

Furthermore, a video data stream according to an embodiment is provided. The video data stream comprises encoded video data encoding a video sequence comprising a sequence of pictures. The video data stream has been generated by an apparatus for encoding according to claim 21, and/or the video data stream has been generated in accordance with the method for encoding as described above.

According to embodiments, motion estimation techniques from classical block-based hybrid video compression are applied to search a motion field, which is then fed into a deep-learned end-to-end video codec. These strategies include different distortion measures, different block partitions and an improved approximation of the residual bitrate. Bitrate savings of up to 12% versus using a neural-network-based motion search are achieved.

Embodiments improve the performance of end-to-end-based video codecs by incorporating the aforementioned classical motion estimation algorithms. The model is based on [16], which uses the scale-space flow with modifications to the interpolation method and encoder optimizations that achieve improvements of up to 20% in terms of BD-rate.

According to embodiments, at first, the motion field generated by a convolutional neural network (CNN) is replaced with a block-based motion field generated by diamond search (see [11]) during inference. Next, this replacement is also incorporated in the training. Then, the motion vector search is modified by adding the abovementioned rate term to the cost criterion. Moreover, the distortion measure is changed to better estimate the behaviour of the residual coding. Finally, additional motion fields using different block sizes are added. The compression benefit of each modification is evaluated individually. Combining them together, bitrate savings of 9.96% for a high bitrate range and 12.23% for a low bitrate range can be achieved.

Embodiments relate to end-to-end based motion compensation which may, e.g., be improved by block-based motion estimation strategies. Combining several approaches such as a rate term in the cost criterion, a distortion measure to estimate the residual coding and multiple motion fields with different block sizes, bitrate savings of 10% for high bit ranges and more than 12% for low rate points are achieved. For the efficient transmission of motion fields in deep learned video compression, techniques from block-based hybrid video coding are beneficially employed.

### BRIEF DESCRIPTION OF THE DRAWINGS

Embodiments of the present invention will be detailed subsequently referring to the appended drawings, in which:

FIG. 1 illustrates an apparatus for determining an encoding of a motion field according to an embodiment.

FIG. 2 illustrates an apparatus for encoding according to an embodiment.

FIG. 3 illustrates an apparatus for decoding according to an embodiment, which is configured to decode a video from encoded video data.

FIG. 4 illustrates a system according to an embodiment, which comprises the apparatus for encoding of FIG. 2 and the apparatus for decoding according to FIG. 3.

FIG. 5 illustrates a table, which depicts an overview of the architecture for the motion compensated prediction.

FIG. 6 illustrates a search pattern for a diamond search with an integer search with large diamond search pattern and a small diamond search pattern according to an embodiment.

FIG. 7 illustrates a search pattern for a diamond search according to another embodiment, with a half-pel search.

FIG. 8 illustrates four neighbors of an embodiment, which form together with the zero motion and the next higher block size the starting candidates for the diamond search.

FIG. 9 illustrates a table which depicts a description of different experimental setups.

FIG. 10 illustrates a table which depicts the Bjontegaard-Delta rate of experiments.

### DETAILED DESCRIPTION OF THE INVENTION

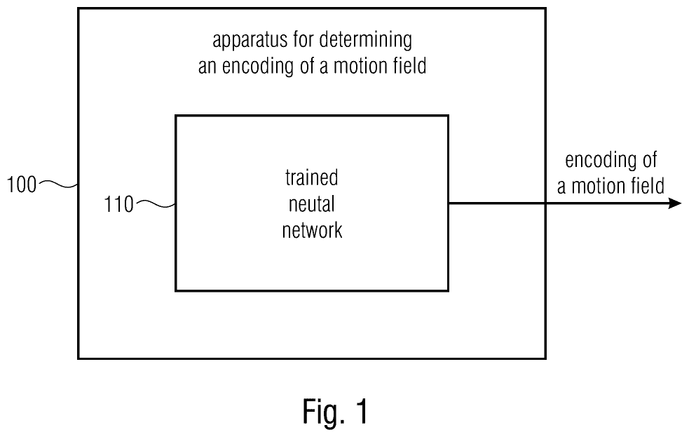

FIG. 1 illustrates an apparatus 100 for determining an encoding of a motion field for a picture of a video sequence comprising a sequence of pictures, such that said picture is decodable using a reference picture, the motion field and the residual, according to an embodiment.

The apparatus 100 of FIG. 1 comprises a trained neural network 110 configured to determine the encoding of the motion field, being associated with said picture, depending on said picture and depending on the reference picture.

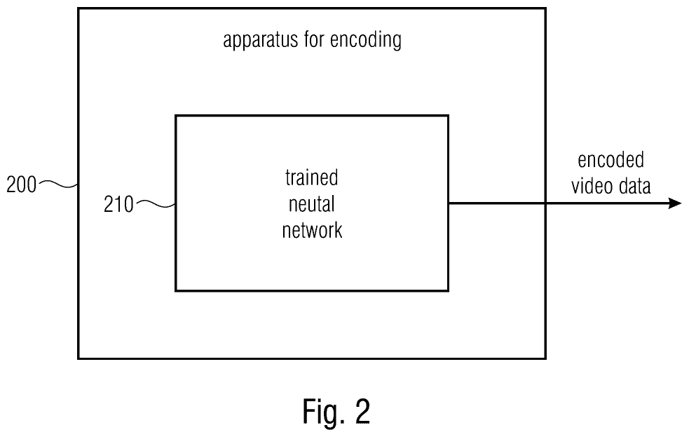

FIG. 2 illustrates an apparatus 200 for encoding according to an embodiment.

The apparatus 200 of FIG. 2 is configured to encode a video sequence comprising a sequence of pictures to obtain encoded video data.

Furthermore, the apparatus 200 of FIG. 2 is configured to generate the encoded video data such that each picture of one or more pictures of the video sequence is encoded by an encoding of a motion field and a residual, such that said picture is decodable using a reference picture, the motion field and the residual.

The apparatus 200 of FIG. 2 comprises a trained neural network 210 configured to determine the encoding of the motion field, being associated with said picture, depending on said picture and depending on the reference picture.

According to an embodiment, the apparatus 100, 200 of FIG. 1 or FIG. 2 may, e.g., be configured to determine the motion field using a block-based motion search strategy. The trained neural network 110, 210 may, e.g., be configured to determine the encoding of the motion field.

In an embodiment, the apparatus 100, 200 of FIG. 1 or FIG. 2 may, e.g., be configured to determine two or more motion fields using the block-based motion search strategy, wherein the trained neural network 110, 210 may, e.g., be configured to determine the encoding of the motion field depending on the two or more motion fields that have been determined using the block-based motion search strategy.

According to an embodiment, the apparatus 100, 200 of FIG. 1 or FIG. 2 may, e.g., be configured to determine the encoding of the motion field depending on the two or more motion fields by employing a cost function.

In an embodiment, the two or more motion fields exhibit different block sizes, for example, 8×8, and/or 16×16, and/or 32×32, and/or 64×64.

According to an embodiment, the apparatus 100, 200 of FIG. 1 or FIG. 2 may, e.g., be configured to determine the motion field or the one or more motion fields using the block-based motion search strategy without using a neural network 110, 210. The trained neural network 110, 210 may, e.g., be configured to determine the encoding of the motion field depending on the motion field or depending on the one or more motion fields.

In an embodiment, the block-based motion strategy comprises a block-based diamond search.

According to an embodiment, the block-based motion strategy comprises a to determine the motion field depending on a sub-pel search.

In an embodiment, the trained neural network 110, 210 has been trained using a minimization function or optimization function, which depends on a predicted picture and an original picture, wherein the predicted picture may, e.g., be a picture that results from decoding using a reference picture and a motion field which are associated with said predicted picture.

According to an embodiment, the neural network 110, 210 has been trained comprising minimizing a mean squared error between a predicted picture and an original picture.

In an embodiment, the neural network 110, 210 has been trained comprising minimizing a rate which depends on the motion field and/or on a residual.

According to an embodiment, the neural network 110, 210 has been trained comprising the minimizing of a rate which depends on a rate of a block-based transform coder for the residual.

According to an embodiment, the neural network 110, 210 has been trained comprising the minimizing of the rate depending on

$${\sum }_{k} - {log}_{2} {P}_{z} ( {\tilde{z}}_{k} , ( \hat{{μ}_{k}} , \hat{{σ}_{k}} ) ) + {\sum }_{l} - {log}_{2} {P}_{y} ( {\tilde{y}}_{l} , ϕ ) ,$$

and/or depending on

$${{{κ {\sum }_{{𝔅}_{j}} ‖ DCT ( {x}_{i + 1} \vert}_{{𝔅}_{j}} - {\overline{x}}_{i + 1} \vert}_{{𝔅}_{j}} ) ‖}_{1} .$$

According to an embodiment, the neural network 110, 210 has been trained comprising the minimizing of the mean squared error between the predicted picture and the original picture and further comprising minimizing a rate which depends on the motion field and/or on a residual.

In an embodiment, the neural network 110, 210 has been trained comprising a minimizing of a distortion measure.

According to an embodiment, the trained neural network 110, 210 has been trained to determine the motion field depending on a block-based diamond search that has been conducted to obtain training data for the neural network 110, 210.

In an embodiment, the trained neural network 110, 210 has been trained to determine the motion field depending on a sub-pel search that has been conducted to generate training data that has been conducted to obtain training data for the neural network 110, 210.

According to an embodiment, the trained neural network 110, 210 has been trained with generated training data.

In an embodiment, the trained neural network 110, 210 has been trained with the generated training data which has been generated by a signal-dependent gradient descent approach.

According to an embodiment, the apparatus 100, 200 of FIG. 1 or FIG. 2 for encoding may, e.g., be configured to generate a video data stream comprising the encoded video data.

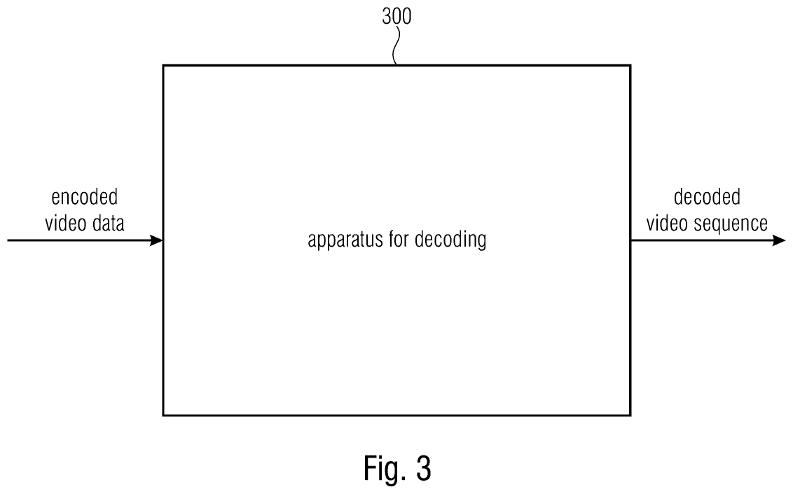

FIG. 3 illustrates an apparatus 300 for decoding according to an embodiment.

The apparatus 300 for decoding is configured to receive encoded video data encoding a video sequence comprising a sequence of pictures.

Moreover, the apparatus 300 for decoding is configured to decode the video from the encoded video data.

Furthermore, the apparatus 300 for decoding is suitable to decode the video sequence from encoded video data being generated by an apparatus 200 for encoding according to one of the above-described embodiments.

According to an embodiment the apparatus 300 for decoding may, e.g., be configured to decode the video sequence from a video data stream comprising the encoded video data. The apparatus for decoding 300 may, e.g., suitable to decode the video sequence from a video data stream being generated by an apparatus 200 for encoding according to one of the above-described embodiments.

In an embodiment, weights of the apparatus 300 for decoding may, e.g., be updated or set depending on a training of the trained neural network 210 of the apparatus 200 for encoding according to one of the above-described embodiments.

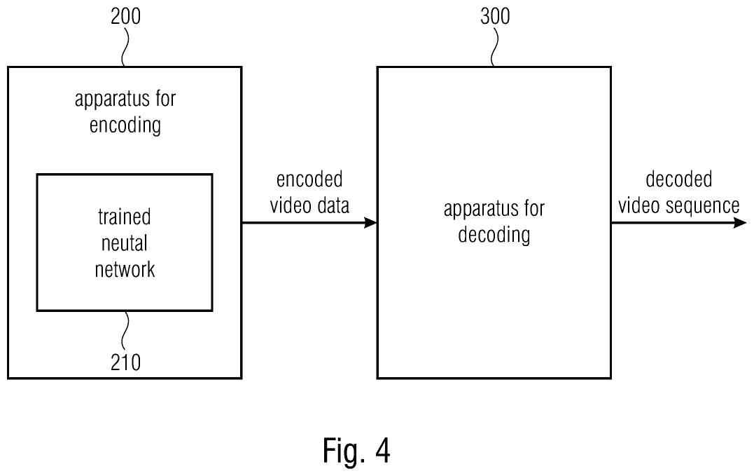

FIG. 4 illustrates a system according to an embodiment.

The system comprises an apparatus 200 for encoding according to one of the above-described embodiments and an apparatus 300 for decoding according to one of the above-described embodiments.

The apparatus 200 for encoding is configured to encode a video sequence comprising a sequence of pictures to obtain encoded video data.

The apparatus 300 for decoding is configured to receive the encoded video data which has been generated by the apparatus 200 for encoding.

Moreover, the apparatus 300 for decoding is configured to decode the video sequence from the encoded video data that has been generated by the apparatus 200 for encoding.

According to an embodiment, the apparatus for encoding may, e.g., be configured to generate a video data stream comprising the encoded video data. The apparatus for decoding may, e.g., be configured to decode the video sequence from the video data stream comprising the encoded video data.

Furthermore, a method for determining an encoding of a motion field for a picture of a video sequence comprising a sequence of pictures, such that said picture is decodable using a reference picture, the motion field and the residual, according to an embodiment is provided.

The method for determining an encoding comprises determining the encoding of the motion field, being associated with said picture, depending on said picture and depending on the reference picture using a trained neural network.

Moreover, a method for encoding according to an embodiment is provided.

The method for encoding comprises encoding a video sequence comprising a sequence of pictures to obtain encoded video data.

Furthermore, the method for encoding comprises generating the encoded video data such that each picture of one or more pictures of the video sequence is encoded by an encoding of a motion field and a residual, such that said picture is decodable using a reference picture, the motion field and the residual.

Determining the encoding of the motion field, being associated with said picture, is conducted depending on said picture and depending on the reference picture using a trained neural network.

According to an embodiment, the method for encoding may, e.g., comprise generating a video data stream comprising the encoded video data.

Furthermore, a method according to another embodiment is provided. The method comprises receiving encoded video data encoding a video sequence comprising a sequence of pictures, and decoding the video sequence from the encoded video data. The encoded video data has been generated in accordance with the method for encoding as described above.

According to an embodiment, the method may, e.g., comprise decoding the video sequence from a video data stream comprising the encoded video data. The video data stream may, e.g., have been generated in accordance with the method for encoding described above.

Moreover, a method for training a neural network according to an embodiment is provided. The neural network is to determine an encoding of a motion field for a picture of a video sequence comprising a sequence of pictures, such that said picture is decodable using a reference picture, the motion field and the residual. The method comprises training the neural network using a minimization function or optimization function, which depends on a predicted picture and an original picture, wherein the predicted picture is a picture that results from decoding using a reference picture and a motion field which are associated with said predicted picture.

According to an embodiment, training the neural network may, e.g., comprise minimizing a mean squared error between a predicted picture and an original picture.

In an embodiment, training the neural network may, e.g., comprise minimizing a rate which depends on the motion field and/or on a residual.

According to an embodiment, training the neural network may, e.g., comprise the minimizing of a rate which depends on a rate of a block-based transform coder for the residual.

In an embodiment, training the neural network may, e.g., comprise the minimizing of the rate depending on

$${\sum }_{k} - {log}_{2} {P}_{z} ( {\tilde{z}}_{k} , ( \hat{{μ}_{k}} , \hat{{σ}_{k}} ) ) + {\sum }_{l} - {log}_{2} {P}_{y} ( {\tilde{y}}_{l} , ϕ ) ,$$

and/or depending on

$${{{κ {\sum }_{{𝔅}_{j}} ‖ DCT ( {x}_{i + 1} \vert}_{{𝔅}_{j}} - {\overline{x}}_{i + 1} \vert}_{{𝔅}_{j}} ) ‖}_{1} .$$

According to an embodiment, training the neural network may, e.g., comprise the minimizing of the mean squared error between the predicted picture and the original picture and further comprising minimizing a rate which depends on the motion field and/or on a residual.

In an embodiment, training the neural network may, e.g., comprise a minimizing of a distortion measure.

According to an embodiment, the method may, e.g., comprise training the neural network to determine the motion field depending on a block-based diamond search that has been conducted to obtain training data for the neural network.

In an embodiment, the method may, e.g., comprise training the neural network to determine the motion field depending on a sub-pel search that has been conducted to obtain training data for the neural network.

According to an embodiment, the method may, e.g., comprise generating training data, and training the neural network with the training data which has been generated.

In an embodiment, generating the training data may, e.g., be conducted by employing a signal-dependent gradient descent approach.

Furthermore, computer programs are provided, wherein each of the computer programs is configured to implement one of the above-described methods when being executed on a computer or signal processor.

Moreover, encoded video data according to an embodiment is provided. The encoded video data encodes a video sequence comprising a sequence of pictures. Moreover, the encoded video data has been generated by an apparatus for encoding as described above, and/or the encoded video data has been generated in accordance with the method for encoding as described above.

Furthermore, a video data stream according to an embodiment is provided. The video data stream comprises encoded video data encoding a video sequence comprising a sequence of pictures. The video data stream has been generated by an apparatus 200 for encoding according to one of the above-described embodiments, and/or the video data stream has been generated in accordance with the above-described methods for encoding.

In the following, particular embodiments are provided.

At first, the architecture of an autoencoder is described. Then, a motion estimation algorithm according to an embodiment with refinements and different distortion measures is described. Next, training according to embodiments is discussed. Afterwards, results are presented.

At first, a description of an autoencoder framework is provided.

In the following, the main components of the end-to-end based video coding approach from [8] and its modification from [16] are briefly described.

Let {x₀, x₁, . . . , x_{L}} denote a video sequence to be coded and transmitted consisting of frames xᵢ∈ [symbol] ^{W×H×l}. In order to keep the distortion-computation unambiguous, we restrict ourselves to luma-only frames here. The reference picture \hat{x}ᵢ has previously been coded and the original picture xᵢ₊₁ is transmitted next. For this purpose, a prediction signal x̅ᵢ₊₁ is computed out of the reconstructed frame \hat{x}ᵢ using motion compensation. The prediction residual rᵢ₊₁=xᵢ₊₁−x̅ᵢ₊₁ is coded with VTM-14.0 (see [17]). The reconstructed residual is used to obtain the reconstructed frame \hat{x}ᵢ₊₁=x̅ᵢ₊₁+\hat{r}ᵢ₊₁.

For an efficient representation and transmission of the motion parameters, an autoencoder framework is used. Here, the encoder computes features in a latent space which are subsequently quantized and transmitted via entropy coding. Afterwards, out of the reconstructed features, the motion field is computed to generate a motion compensated prediction.

The motion between the two images is described with a scale-space flow. Therefore, a scale space volume

$$X = [ {\hat{x}}_{i} , {\hat{x}}_{i} * {G}_{0} , {\hat{x}}_{i} * {G}_{1} , … , {\hat{x}}_{i} * {G}_{M} ]$$

which consists of the reference picture \hat{x}ᵢ and M convolutions of \hat{x}ᵢ with a Gaussian kernel Gⱼ is created as an input for the motion compensated prediction. In this setting, the reconstructed motion field f that was transmitted to the decoder is described by a mapping

$$\hat{f} : {ℝ}^{W \times H} \to {ℝ}^{3} , [ x , y ] ↦ ( {\hat{f}}_{hor} [ x , y ] , {\hat{f}}_{ver} [ x , y ] , {\hat{f}}_{scale} [ x , y ] )$$

where \hat{f}ₕₒᵣ and \hat{f}ᵥₑᵣ denote the spatial displacement and \hat{f}_{scale} indicates the scale. As a result, the motion compensated image is calculated as

$${\overline{x}}_{i + 1} [ x , y ] = X [ x + {\hat{f}}_{hor} [ x , y ] , y + {\hat{f}}_{ver} [ x , y ] , {\hat{f}}_{scale} [ x , y ] ] . \qquad ( 1 )$$

Lanczos filtering (see [18]) is used to interpolate X at non-integer positions. It consists of linear interpolation in case of the scale component and two one-dimensional 8-tap Lanczos filter for the spatial components as in [16].

For the coding of the prediction residual, VTM-14.0 in the All-Intra setting without in-loop filters is used as the predicted picture and the residual are not added inside VTM. The first frame xo is also coded in the VTM All-Intra configuration.

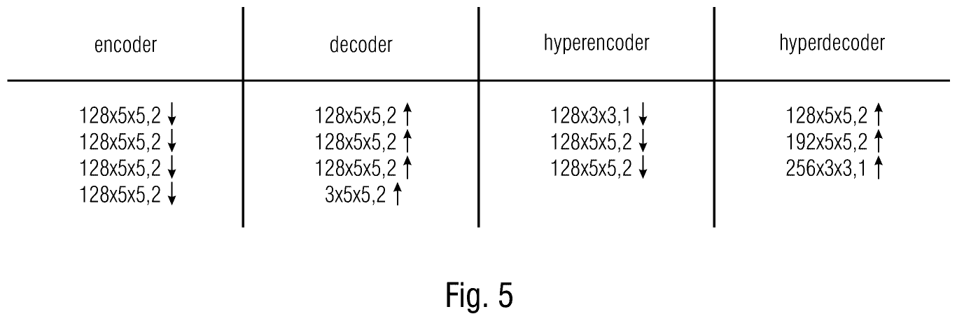

The architecture of the involved encoder and decoder network as well as the hyper networks used for entropy coding is delineated in the table of FIG. 5. In this scenario, the input of the encoder are the original picture xᵢ₊₁ and the reconstructed reference picture out of which the features are computed by a CNN.

In particular, FIG. 5 illustrates a table, which depicts an overview of the architecture for the motion compensated prediction from [16]. M×n×n, s ↑/↓ indicates a convolutional layer with M output channels, a kernel of size n and the arrows indicate up-(↑) or downsampling (↓) with factor s. Each layer is followed by a Relu activation except for the last one in every component.

In the following, motion search according to embodiments is described.

A typical approach in learned video compression is that the encoder network directly uses xᵢ₊₁ and \hat{x}ᵢ as input for determining feature values as a bottleneck representation of the

motion field as in [8], [19]. In [16] the task has been divided into training one network for searching distortion-optimal motion vectors fₚᵣₑ and another network for the actual encoding that uses these vectors as an input. However, trained networks in both settings may have trouble in finding a suitable field f when the motion amplitude is large. Hence, in embodiments, several experimental setups were used to investigate the influence of different motion search strategies.

In contrast to [16], in embodiments, the previous motion search, which used a CNN, has been replaced by traditional block-based motion search strategies. The advantage of these methods is that they are not restricted by a chosen CNN architecture, especially the kernel size and the number of layers. For example, if a kernel size of 5×5 is used, each layer can only compare two neighboring samples in one direction. Although the search radius grows with each layer and downsampling helps to further extend the search radius, this leads to a loss of information. The search regions are bounded and may not be sufficient, especially if large images or bigger temporal distances are used.

At first, diamond search of embodiments is described.

In embodiments, a block-based diamond search (see [11]) may, e.g., be employed, which is one of many strategies to speed up the search progress. The search comprises two search patterns. There is a large diamond search pattern (LDSP) which includes all eight points where the sum of the distance from the center in horizontal and vertical direction equals 2 and the center itself on the full-pel grid.

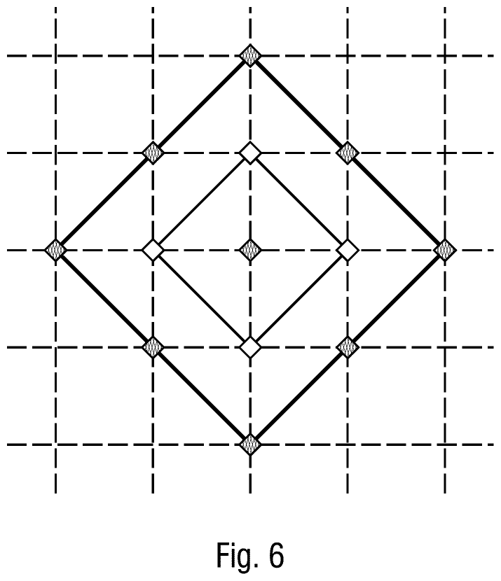

This is illustrated in FIG. 6 by the black dot and the black diamonds. In particular, FIG. 6 illustrates a search pattern for a diamond search with an integer search with large diamond search pattern (black diamonds) and a small diamond search pattern (white diamonds) according to an embodiment. For each point the cost is determined by applying a distortion measure to the residual. In the case that any of the points except for the center has the lowest cost, the center is shifted to that point and the search strategy is repeated. This loop continues until the center point has the lowest cost.

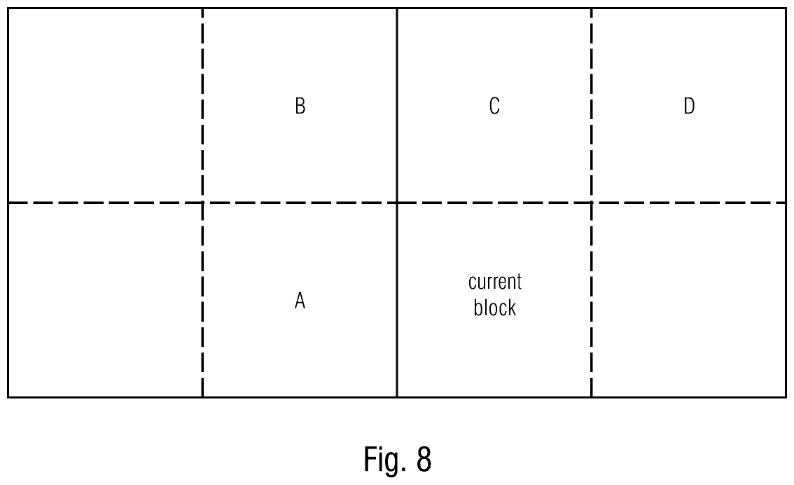

Subsequently, the pattern is switched to the small diamond search pattern (SDSP) which comprises the center and all four points where the sum of the distances equals 1 (see FIG. 6). The point with the lowest cost is then chosen as the searched MV (motion vector). To circumvent the event that the search with the LDSP is stuck in a loop by having multiple points with the smallest cost, the center is checked first and another point is only used, if it is smaller. The image is divided into blocks with block sizes n x n where n is a power of 2, starting with the biggest possible block size and gradually reducing it to 8×8. As the scalespace flow field f consists of a additional scale component, each of the M+1 blurred versions of the reference frame in X is checked for each position. The motion search can start at one of up to six candidate positions for each block, including the zero motion, four spatial neighbors and the next higher block size as shown in FIG. 8. In particular, FIG. 8 illustrates the four neighbors A, B, C and D of an embodiment, which form together with the zero motion and the next higher block size (grey block) the starting candidates for the diamond search.

In the following, sub-pel search according to an embodiment is discussed.

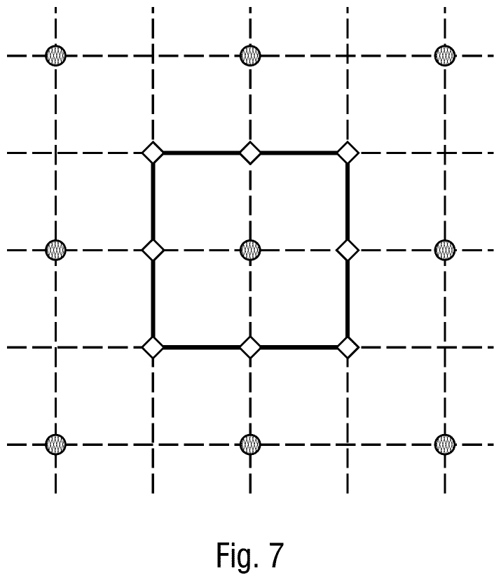

FIG. 7 illustrates a search pattern for a diamond search according to another embodiment, with a half-pel search, as indicated by white diamond, black dots show integer positions. To improve the accuracy of the searched motion field, a sub-pel search is used. We use a fraction al position of 1/16 to match the precision for luma samples that is used in VVC (see [3]). Therefore the grid is successively refined. However, instead of using the same search strategy as in the integer search, according to such an embodiment, only the center and the surrounding 8 points as shown by the white diamonds and the center black dot in FIG. 7 are searched. The center is then shifted to the point with the lowest cost, the grid is refined to the next sub-pel precision and the search strategy is repeated until the 1/16-precision is reached.

In the following, an analysis of different motion search configurations is provided.

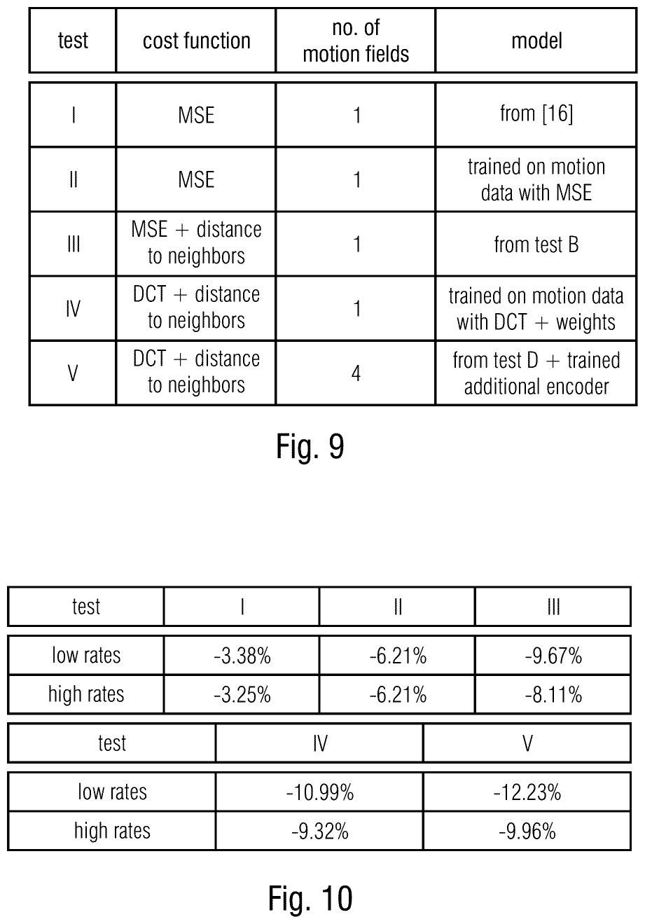

In experiments, different cost functions and granularities used in the motion search according to the embodiments above have been texted. The different test configurations are described in the table of FIG. 9. In particular, FIG. 9 illustrates a table which depicts a description of different experimental setups. For Tests I-IV, the block size of the motion search algorithm according to embodiments provided above is set to 8×8, while it is varied for the last test.

In Test I, the decoder model from [16] has been employed. For the encoder, at first, a motion field has been searched with prediction mean squared error (MSE) as cost criterion. This motion field then replaced the pre-searched motion field fₚᵣₑ from [16] during inference.

In Test II, the motion data fₚᵣₑ has been replaced by a motion field generated as in Test I during training and trained a new model from scratch as described below.

For Test III, the cost function has been modified to favor motion fields that vary smoothly across the blocks of the search.

More precisely, a weighted minimal I1-distance between a motion vector candidate and the already determined motion vectors of neighboring blocks A, B, C, D (see FIG. 2) has been added to the cost function. This also resembles motion search strategies used in classical hybrid block-based video coding, where motion information of a given block is predictively coded from the motion information of neighboring blocks.

In Test IV, we replaced the prediction MSE by the I1-norm of the prediction error in the DCT-II-domain. This is motivated by the fact that we code the residual with VTM All-Intra, for which the latter distortion measure is known to be a more accurate approximation of the

coding cost than the prediction MSE (see [20], [21]). It should be noted that a similar cost criterion is also used during the training of the autoencoder network (see equation (2)).

In the last Test V, four motion fields have been combined that are searched on the different block sizes 8×8, 16×16, 32×32 and 64×64 with the cost function of Test IV. For these tests, the architecture is slightly changed. First, the encoder is run four times with different inputs. The created features z for each of the motion fields are then concatenated along the last axis to create a vector

$${z}^{*} ∈ {ℝ}^{\frac{H}{16} \times \frac{W}{16} \times 512} .$$

Since the decoder network expects 128 channels, z* is fed into an additional network consisting of two convolutional layers with kernel size 3×3 and a ReLu activation after the first layer.

In the following, training details are provided.

In the training, stochastic gradient descent with the Adam optimizer [22] with the settings described in [16] has been employed. The employed dataset is the BVI-DVC dataset [23] cropped to 256×256 luma-only patches and corresponding motion fields searched as specified above. The training comprises two stages with different cost functions. First, the autoencoder network is trained to minimize D+λR_{mf} with D as MSE of the prediction residual MSE(x̅ᵢ₊₁, Xᵢ₊₁). R_{mf} denotes the bitrate of the quantized features \hat{z} and quantized hyper priors ŷ which are transmitted to generate the motion field. It is estimated with the cross entropy:

$${R}_{mf} \approx {\sum }_{k} - {log}_{2} {P}_{z} ( {\tilde{z}}_{k} , ( {\hat{μ}}_{k} , {\hat{σ}}_{k} ) ) + {\sum }_{l} - {log}_{2} {P}_{y} ( {\tilde{y}}_{l} , ϕ ) ,$$

with k and l as associated multi-index of x-, y-component and channel. The second training step trains the network to minimize an estimation of the total rate

$${R}_{total} = {R}_{mf} + {R}_{res} , \qquad ( 2 )$$

$${{{{R}_{res} = κ {\sum }_{{𝔅}_{j}} ‖ DCT ( {x}_{i + 1} \vert}_{{𝔅}_{j}} - {\overline{x}}_{i + 1} \vert}_{{𝔅}_{j}} ) ‖}_{1} ,$$

where Rᵣₑₛ estimates the rate of the residual using the block-based transform coder. Both the predicted and the original picture are partitioned in 16×16 blocks which is denoted by { [symbol] ⱼ}_{j∈J}. Then the separable DCT-II transform DCT(·) is applied to the residual restricted to such a block [symbol] ⱼ as described by x| [symbol] ⱼ. Afterwards, the I1-norms ∥·∥_{λ} over the different blocks are [symbol] ⱼ computed and summed up.

For the Test V above, an additional network on the encoder side consisting of two convolutional layers was trained with respect to the cost function (2).

During inference, in all tests a signal-dependent rate distortion optimization of the features is used which is implemented by optimizing the features with respect to (2) using a gradient descent.

Regarding the experiments, the table of FIG. 10 shows the results on 20 sequences of the BVI-DVC dataset, which were excluded from the training. In particular, FIG. 10 illustrates a table which depicts the Bjontegaard-Delta rate (BD-rate) of experiments.

As a baseline, the autoencoder from [16] with all tools on is used. Each configuration was tested for 5 rate points with QP 17, 22, 27, 32 and 37 in the I frame and an QP offset of 5 for the P frame. The improvements are measured in terms of Bjontegaard-Delta rate (see [24]), also known as BD-rate. “Low rates” indicate the BD-rate for QPs 22-37 and “High rates” describe the BD-rate for QPs 17-32.

As shown by the results, the performance can be improved by over 3% by replacing the motion field generated by a CNN with a block-based motion field in Test I. This shows that block-based motion estimation can improve the results even by keeping the same encoder and decoder. Retraining the model with the block-based motion improves the results by the same margin (see Test II). Implementing an approximation of the rate in Test III results in a gain of 3.5% for the 4 lowest rate points and around 2% for the 4 highest rate points. Especially, the lower rate points benefit from a smoother motion field as a less detailed image is reconstructed.

Changing the distortion measure to the I1-norm in the DCT-II-domain as in Test IV further improves the performance by around 1.2%. This supports the assumption that a distortion measure which is more suitable to the residual coding can improve the performance. As reported in Test V, further gain can be achieved by using 4 motion fields, where the gain for low bitrate operation points is higher than for higher rate points. The more significant gain in the low bit range can be explained by the fact that the motion vector rate is more critical in the latter scenario.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] “Advanced Video Coding for Generic Audio-Visual Services,” ITU-T Rec. H.264 and ISO/IEC 14496-10, 2003.
[2] “High Efficiency Video Coding,” ITU-T Rec. H.265 and ISO/IEC 23008-2, 2013.
[3] B. Bross, J. Chen, J. R. Ohm, G. J. Sullivan, and Y. K. Wang, “Developments in International Video Coding Standardization After AVC, With an Overview of Versatile Video Coding (VVC),” Proceedings of the IEEE, pp. 1-31, 2021.
[4] “Versatile Video Coding,” ITU-T Rec. H.266 and ISO/IEC 23090-3, 2020.
[5] D. Minnen, J. Ballé, and G. D. Toderici, “Joint autoregressive and hierarchical priors for learned image compression,” Advances in neural information processing systems, vol. 31, 2018.
[6] G. Lu, W. Ouyang, D. Xu, X. Zhang, C. Cai, and Z. Gao, “DVC: An end-to-end deep video compression framework,” in Proceedings of the IEEE/CVF Conference on Computer Vision and Pattern Recognition, 2019, pp. 11006-11015.
[7] G. Lu, C. Cai, X. Zhang, L. Chen, W. Ouyang, D. Xu, and Z. Gao, “Content adaptive and error propagation aware deep video compression,” in European Conference on Computer Vision. Springer, 2020, pp. 456-472.
[8] E. Agustsson, D. Minnen, N. Johnston, J. Ballé, S. J. Hwang, and G. Toderici, “Scale-space flow for end-to-end optimized video compression,” in Proceedings of the IEEE/CVF Conference on Computer Vision and Pattern Recognition, 2020, pp. 8503-8512.
[9] I. Kim, J. Min, T. Lee, W. Han, and J. Park, “Block partitioning structure in the HEVC standard,” IEEE transactions on circuits and systems for video technology, vol. 22, no. 12, pp. 1697-1706, 2012.
[10] W.-J. Chien, L. Zhang, M. Winken, X. Li, R.-L. Liao, H. Gao, C.-W. Hsu, H. Liu, and C.-C. Chen, “Motion vector coding and block merging in the versatile video coding standard,” IEEE Transactions on Circuits and Systems for Video Technology, vol. 31, no. 10, pp. 3848-3861, 2021.
[11] Shan Zhu and Kai-Kuang Ma, “A new diamond search algorithm for fast block-matching motion estimation,” IEEE transactions on Image Processing, vol. 9, no. 2, pp. 287-290, 2000.
[12] Jaswant Jain and Anil Jain, “Displacement measurement and its application in interframe image coding,” IEEE Transactions on communications, vol. 29, no. 12,pp. 1799-1808, 1981.
[13] Berthold KP Horn and Brian G Schunck, “Determining optical flow,” Artificial intelligence, vol. 17, no. 1-3, pp. 185-203, 1981.
[14] Salih Dikbas and Yucel Altunbasak, “Novel true-motion estimation algorithm and its application to motion-compensated temporal frame interpolation,” IEEE Transactions on Image Processing, vol. 22, no. 8, pp. 2931-2945, 2012.
[15] Chris Bartels and Gerard de Haan, “Smoothness constraints in recursive search motion estimation for picture rate conversion,” IEEE Transactions on Circuits and Systems for Video Technology, vol. 20, no. 10, pp. 1310-1319, 2010.
[16] S. Pientka, M. Schafer, J. Pfaff, H. Schwarz, D. Marpe, and T. Wiegand, “Deep video coding with gradient-descent optimized motion compensation and lanczos filtering,” in 2022 Picture Coding Symposium (PCS). IEEE, 2022, pp. 169-173.
[17] A. Browne, J. Chen, Y. Ye, and S. Kim, “Algorithm description for Versatile Video Coding and Test Model 14 (VTM 14),” JVET-W2002, Joint Video Experts Team (JVET), July 2021.
[18] Claude E Duchon, “Lanczos filtering in one and two dimensions,” Journal of Applied Meteorology and Climatology, vol. 18, no. 8, pp. 1016-1022, 1979.
[19] O. Rippel, S. Nair, C. Lew, S. Branson, A. Anderson, and L. Bourdev, “Learned video compression,” in Proceedings of the IEEE/CVF International Conference on Computer Vision, 2019, pp. 3454-3463.
[20] Zhihai He and Sanjit K Mitra, “A linear source model and a unified rate control algorithm for dct video coding,” IEEE transactions on Circuits and Systems for Video Technology, vol. 12, no. 11, pp. 970-982, 2002.
[21] Edmund Y Lam and Joseph W Goodman, “A mathematical analysis of the dct coefficient distributions for images,” IEEE transactions on image processing, vol. 9, no. 10, pp. 1661-1666, 2000.
[22] Diederik P. Kingma and Jimmy Ba, “Adam: A Method for Stochastic Optimization,” in ICLR 2015, Conference Track Proceedings, Yoshua Bengio and Yann Le-Cun, Eds., 2015.
[23] D. Ma, F. Zhang, and D. Bull, “BVI-DVC: A training database for deep video compression,” IEEE Transactions on Multimedia, 2021.
[24] Gisle Bjontegaard, “Calculation of average psnr differences between rd-curves,” VCEG-M33, 2001.

1. An apparatus for determining an encoding of a motion field for a picture of a video sequence comprising a sequence of pictures, such that said picture is decodable using a reference picture, the motion field and the residual,
wherein the apparatus comprises a trained neural network configured to determine the encoding of the motion field, being associated with said picture, depending on said picture and depending on the reference picture.

2. An apparatus for encoding,
wherein the apparatus is configured to encode a video sequence comprising a sequence of pictures to acquire encoded video data,
wherein the apparatus is configured to generate the encoded video data such that each picture of one or more pictures of the video sequence is encoded by an encoding of a motion field and a residual, such that said picture is decodable using a reference picture, the motion field and the residual;
wherein the apparatus comprises a trained neural network configured to determine the encoding of the motion field, being associated with said picture, depending on said picture and depending on the reference picture.

3. An apparatus according to claim 1,
wherein the apparatus is configured to determine the motion field using a block-based motion search strategy, and wherein the trained neural network is configured to determine the encoding of the motion field.

4. An apparatus according to claim 1,
wherein the apparatus is configured to determine two or more motion fields using the block-based motion search strategy, wherein the trained neural network is configured to determine the encoding of the motion field depending on the two or more motion fields that have been determined using the block-based motion search strategy.

5. An apparatus according to claim 4,
wherein the apparatus is configured to determine the encoding of the motion field depending on the two or more motion fields by employing a cost function.

6. An apparatus according to claim 4,
wherein the two or more motion fields exhibit different block sizes, for example, 8×8, and/or 16×16, and/or 32×32, and/or 64×64.

7. An apparatus according to claim 3,
wherein the apparatus is configured to determine the motion field or the one or more motion fields using the block-based motion search strategy without using a neural network, and
wherein the trained neural network is configured to determine the encoding of the motion field depending on the motion field or depending on the one or more motion fields.

8. An apparatus according to claim 3,
wherein the block-based motion strategy comprises a block-based diamond search.

9. An apparatus according to claim 3,
wherein the block-based motion strategy comprises a to determine the motion field depending on a sub-pel search.

10. An apparatus according to claim 1,
wherein the trained neural network has been trained using a minimization function or optimization function, which depends on a predicted picture and an original picture, wherein the predicted picture is a picture that results from decoding using a reference picture and a motion field which are associated with said predicted picture.

11. An apparatus according to claim 10,
wherein the neural network has been trained comprising minimizing a mean squared error between a predicted picture and an original picture.

12. An apparatus according to claim 10,
wherein the neural network has been trained comprising minimizing a rate which depends on the motion field and/or on a residual.

13. An apparatus according to claim 12,
wherein the neural network has been trained comprising the minimizing of a rate which depends on a rate of a block-based transform coder for the residual.

14. An apparatus according to claim 12,
wherein the neural network has been trained comprising the minimizing of the rate depending on
$${\sum }_{k} - {log}_{2} {P}_{z} ( {\tilde{z}}_{k} , ( \hat{{μ}_{k}} , \hat{{σ}_{k}} ) ) + {\sum }_{l} - {log}_{2} {P}_{y} ( {\tilde{y}}_{l} , ϕ ) ,$$
and/or depending on
$${{{κ {\sum }_{{𝔅}_{j}} ‖ DCT ( {x}_{i + 1} \vert}_{{𝔅}_{j}} - {\overline{x}}_{i + 1} \vert}_{{𝔅}_{j}} ) ‖}_{1} .$$

15. An apparatus according to claim 9,
wherein the neural network has been trained comprising the minimizing of the mean squared error between the predicted picture and the original picture and further comprising minimizing a rate which depends on the motion field and/or on a residual.

16. An apparatus according to claim 9,
wherein the neural network has been trained comprising a minimizing of a distortion measure.

17. An apparatus according to claim 1,
wherein the trained neural network has been trained to determine the motion field depending on a block-based diamond search that has been conducted to acquire training data for the neural network.

18. An apparatus according to claim 1,
wherein the trained neural network has been trained to determine the motion field depending on a sub-pel search that has been conducted to generate training data that has been conducted to acquire training data for the neural network.

19. An apparatus according to claim 1,
wherein the trained neural network has been trained with generated training data.

20. An apparatus according to claim 19,
wherein the trained neural network has been trained with the generated training data which has been generated by a signal-dependent gradient descent approach.

21. An apparatus for encoding according to claim 2,
wherein the apparatus for encoding is configured to generate a video data stream comprising the encoded video data.

22. An apparatus for decoding,
wherein the apparatus for decoding is configured to receive encoded video data encoding a video sequence comprising a sequence of pictures,
wherein the apparatus for decoding is configured to decode the video from the encoded video data,
wherein the apparatus for decoding is suitable to decode the video sequence from encoded video data being generated by an apparatus for encoding according to claim 2.

23. An apparatus for decoding according to claim 22,
wherein the apparatus for decoding is configured to decode the video sequence from a video data stream comprising the encoded video data,
wherein the apparatus for decoding is suitable to decode the video sequence from a video data stream being generated by an apparatus for encoding according to claim 21.

24. An apparatus according to claim 22,
wherein weights of the apparatus for decoding are updated or set depending on a training of the trained neural network of the apparatus for encoding according to claim 2.

25. A system, comprising:
an apparatus for encoding according to claim 2, and
an apparatus for decoding according to claim 22,
wherein the apparatus for encoding is configured to encode a video sequence comprising a sequence of pictures to acquire encoded video data,
wherein the apparatus for decoding is configured to receive the encoded video data which has been generated by the apparatus for encoding, and
wherein the apparatus for decoding is configured to decode the video sequence from the encoded video data that has been generated by the apparatus for encoding.

26. A system according to claim 25,
wherein the apparatus for encoding is an apparatus for encoding according to claim 21,
wherein the apparatus for decoding is an apparatus for decoding according to claim 23,
wherein the apparatus for encoding is configured to generate a video data stream comprising the encoded video data,
wherein the apparatus for decoding is configured to decode the video sequence from the video data stream, which has been generated by the apparatus for encoding and which comprises the encoded video data.

27. A method for determining an encoding of a motion field for a picture of a video sequence comprising a sequence of pictures, such that said picture is decodable using a reference picture, the motion field and the residual,
wherein the method comprises determining the encoding of the motion field, being associated with said picture, depending on said picture and depending on the reference picture using a trained neural network.

28. A method for encoding,
wherein the method comprises encoding a video sequence comprising a sequence of pictures to acquire encoded video data,
wherein the method comprises generating the encoded video data such that each picture of one or more pictures of the video sequence is encoded by an encoding of a motion field and a residual, such that said picture is decodable using a reference picture, the motion field and the residual;
wherein determining the encoding of the motion field, being associated with said picture, is conducted depending on said picture and depending on the reference picture using a trained neural network.

29. A method according to claim 28,
wherein the method comprises generating a video data stream comprising the encoded video data.

30. A method comprising:
receiving encoded video data encoding a video sequence comprising a sequence of pictures, and
decoding the video sequence from the encoded video data,
wherein the encoded video data has been generated in accordance with the method of claim 28.

31. A method according to claim 30,
wherein the method comprises decoding the video sequence from a video data stream comprising the encoded video data,
wherein the video data stream has been generated in accordance with the method of claim 29.

32. A method for training a neural network, wherein the neural network is to determine an encoding of a motion field for a picture of a video sequence comprising a sequence of pictures, such that said picture is decodable using a reference picture, the motion field and the residual,
wherein the method comprises training the neural network using a minimization function or optimization function, which depends on a predicted picture and an original picture, wherein the predicted picture is a picture that results from decoding using a reference picture and a motion field which are associated with said predicted picture.

33. A method according to claim 32,
wherein training the neural network comprises minimizing a mean squared error between a predicted picture and an original picture.

34. A method according to claim 32,
wherein training the neural network comprises minimizing a rate which depends on the motion field and/or on a residual.

35. A method according to claim 34,
wherein training the neural network comprises the minimizing of a rate which depends on a rate of a block-based transform coder for the residual.

36. A method according to claim 34,
wherein training the neural network comprises the minimizing of the rate depending on
$${\sum }_{k} - {log}_{2} {P}_{z} ( {\tilde{z}}_{k} , ( \hat{{μ}_{k}} , \hat{{σ}_{k}} ) ) + {\sum }_{l} - {log}_{2} {P}_{y} ( {\tilde{y}}_{l} , ϕ ) ,$$
and/or depending on
$${{{κ {\sum }_{{𝔅}_{j}} ‖ DCT ( {x}_{i + 1} \vert}_{{𝔅}_{j}} - {\overline{x}}_{i + 1} \vert}_{{𝔅}_{j}} ) ‖}_{1} .$$

37. A method according to claim 32,
wherein training the neural network comprises the minimizing of the mean squared error between the predicted picture and the original picture and further comprising minimizing a rate which depends on the motion field and/or on a residual.

38. A method according to claim 32,
wherein training the neural network comprises a minimizing of a distortion measure.

39. A method according to claim 32,
wherein the method comprises training the neural network to determine the motion field depending on a block-based diamond search that has been conducted to acquire training data for the neural network.

40. A method according to claim 32,
wherein the method comprises training the neural network to determine the motion field depending on a sub-pel search that has been conducted to acquire training data for the neural network.

41. A method according to claim 32,
wherein the method comprises generating training data, and training the neural network with the training data which has been generated.

42. A method according to claim 41,
wherein generating the training data is conducted by employing a signal-dependent gradient descent approach.

43. A computer program for implementing the method of claim 27 when being executed on a computer or signal processor.

44. Encoded video data,
wherein the encoded video data encodes a video sequence comprising a sequence of pictures,
wherein the encoded video data has been generated by an apparatus for encoding according to claim 2, and/or
wherein the encoded video data has been generated in accordance with the method of claim 28.

45. A video data stream,
wherein the video data stream comprises encoded video data encoding a video sequence comprising a sequence of pictures,
wherein the video data stream has been generated by an apparatus for encoding according to claim 21, and/or
wherein the video data stream has been generated in accordance with the method of claim 29.
